(19) United States
(12) Patent Application Publication
(10) Pub. No.: US 2008/0010079 A1
(43) Pub. Date: Jan. 10, 2008

(54) Printing device, printing system, print control method and print control program for use therein

(75) Inventor: Daisuke Genda, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/812,915

(22) Filed: Jun. 22, 2007

(30) Foreign Application Priority Data
Jul. 5, 2006 (JP) JP2006-185894

(51) Int. Cl. G06Q 99/00; B41J 29/00; G03G 21/00; H04N 1/00; G06F 17/30

(52) U.S. Cl. 705/1; 101/483; 358/1.1; 700/90

(57) ABSTRACT

A printing device capable of printing for which a user who receives a printed matter is specified, the printing device comprising: an authentication section which identifies a user who approaches the printing device; and a notification controller which causes a notifying section to make a notification of prescribed information when a job to be outputted for the identified user is registered.

This application is based on Japanese Patent Application No. 2006-185894 filed on Jul. 5, 2006, which is incorporated hereinto by reference.

### BACKGROUND OF THE INVENTION

The present invention relates to a printing device, a printing system, a print control method, and a print control program for use therein, and more particularly to a printing device having a confidential printing function, a printing system including the printing device, a print control method, and a print control program for use therein.

Recently, multi-functional products including a copy function, a facsimile function, a printer function, a scanner function, and the like are widely used (these products will be simply referred to below as printing devices). In offices, a printing device of this type is connected to a LAN or another communication network so that a plurality of users can share this printing device.

The above printing device has a so-called confidential printing function, which executes printing only for a user specified for reception of a printed matter. Upon receipt of a confidential print addressed for the specified user, the printing device records print data for the confidential print in a memory section. When the specified user enters a user's ID (identification) and password from the operation part on the printing device and is authenticated, the printing device outputs the print data to paper or another medium.

To quickly deliver the above confidential print to the specified user, there is also provided a printing device that has a function for generating mail to notify the specified user when a confidential print arrives for the user.

To enhance security of confidential prints, Unexamined Japanese Patent Application Publication No. 2005-123699 discloses an arrangement in which the use of functions of an image processing apparatus is permitted according to a biological information authentication result given by a biological information authentication apparatus in which a biological information recognition sensor for capturing biological information (such as the fingerprints and face) of the operator and a biological information authentication controller for comparing the biological information captured by the biological information recognition sensor are unitized.

Unexamined Japanese Patent Application Publication No. 2004-252501 discloses an arrangement in which a printing system comprises a first authentication information collection section for collecting authentication information (such as face data) of the user, an integrating section for integrating the authentication information into print data, an output section for outputting the integrated data to a printing device, a separation section for separating the authentication information from the print data, a comparison section for comparing the separated authentication information with authentication information collected by a second authentication information collection section, and a print controller for printing the print data when a match is found between the two authentication information items.

In these conventional methods, however, the user can know whether there is a confidential print only after the user logs in to the printing device. There may be a case in which time passes from when a confidential print arrives until print data is output. The user has to go to the printing device many times to check for the presence or absence of a confidential print, and enter the ID and password so as to log in, making the operation complicated.

Even in the method in which mail is used to make a notification that a confidential print has arrived, the user cannot know the arrival of the confidential print until the user receives the mail and reads the received mail; when the user knows the arrival, the user must go to the printing device to output the confidential print. Accordingly, the method is very cumbersome.

In the above method in which biological information is used as disclosed in Unexamined Japanese Patent Application Publication No. 2005-123699, a process for entering an ID and password can be eliminated, but the user cannot know the presence or absence of a confidential print until the user logs in to the printing device and has to go to the printing device many times and log in to check for the presence or absence of a confidential print.

In the above method described in Unexamined Japanese Patent Application Publication No. 2004-252501, authentication information must be integrated each time print data is created, making the operation complicated. An integration section and a separation section are also needed, so the method is not a general-purpose method and thus it is difficult to apply the method to existing printing systems.

### SUMMARY OF THE INVENTION

One aspect of the present invention is a printing device that is capable of performing printing for which a user who receives a printed matter is specified; the printing device comprises an authentication section for identifying a user who is approaching the printing device and a notification controller for causing a notifying section to make a notification of prescribed information when a job yet to be output for the identified user is registered.

Another aspect of the present invention is a printing system in which one printing device or a plurality of printing devices capable of performing printing for which a user who receives a printed matter is specified are at least connected through a communication network to a server in which distinguishing information about users who use these printing devices are registered in connection with their image information; at least one of the plurality of printing devices comprises an authentication section for identifying a user who is approaching the printing device and a notification controller for causing a notifying section to make a notification of prescribed information when a job yet to be output for the identified user is registered.

Still another aspect of the present invention is a print control method in which a printing device capable of performing printing for which a user who receives a printed matter is specified; the print control method comprises the step of authenticating for identifying a user who is approaching the printing device and the step of notifying for making a notification of prescribed information when a job yet to be output for the identified user is registered.

Still another aspect of the present invention is a program that operates in a printing device that is capable of performing printing for which a user who receives a printed matter is specified; a computer functions as an authentication section for identifying a user near the printing device, who is photographed by a photographing section mounted in or connected to the printing device, by comparing image information about the user with image information registered in advance in connection with distinguishing information about users who may use the printing device, and as a notification controller for causing a notifying section to make a notification of a message including the distinguishing information about the user when a job yet to be output for the identified user is registered.

Yet still another aspect of the present invention is a program that operates in a printing device that is capable of performing printing for which a user who receives a printed matter is specified; a computer functions as an authentication section for identifying a user near the printing device, by comparing authentication information about the user with image information registered in advance in connection with distinguishing information about users who may use the printing device, the authentication information being recorded in an authentication medium possessed by the user and read by a reading section mounted in or connected to the printing device, and as a notification controller for causing a notifying section to make a notification of a message including the distinguishing information about the user when a job yet to be output for the identified user is registered.

### BRIEF DESCRIPTION OF THE DRAWINGS

FIG. 1 schematically shows the structure of a printing system according to an embodiment of the present invention.

FIG. 2 is a perspective view showing an exemplary structure of a printing device according to an embodiment of the present invention.

FIG. 3 is a perspective view showing another exemplary structure of a printing device according to an embodiment of the present invention.

FIG. 4 is a perspective view showing still another exemplary structure of a printing device according to an embodiment of the present invention.

FIG. 5 is a perspective view showing still another exemplary structure of a printing device according to an embodiment of the present invention.

FIG. 6 is a perspective view showing yet still another exemplary structure of a printing device according to an embodiment of the present invention.

FIG. 7 is a block diagram showing the structure of the printing device according to the embodiment of the present invention.

FIG. 8 is a flowchart indicating a procedure for outputting a confidential print in a system according to the embodiment of the present invention.

FIG. 9 indicates an exemplary job yet to be output to the printing device according to the embodiment of the present invention.

FIG. 10 shows an exemplary database, registered in the printing device according to the embodiment of the present invention or a server, in which users' IDs is in connection with face images thereof.

### DETAILED DESCRIPTION OF THE PREFERRED EMBODIMENT

As described above as prior art, when a printing device shared by a plurality of users is used to output a confidential print, a confidential facsimile, and other print data, the user has to go to the printer many times and enter the user's ID and password to check for the presence or absence of print data addressed for the user. When mail is used to make a notification that print data has arrived, the user also has to go to the printer to output the print data. Even when biological information is used instead of entering the ID and password, the user still has to go to the printer to log in, making the printing device inconvenient.

This type of problem is attributable to the necessity of the user moving between the printing device and the desk thereof many times to check for the presence or absence of print data addressed for the user or to output print data. Since the printing device is shared by a plurality of users, the printing device is installed on, for example, a passageway through which the plurality of users often pass so that they can access the printing device easily. For example, when moving to attend a conference or the like, the user often passes in front of the printing device.

Accordingly, the present invention addresses the particularity of office environments as described above so that when a user passes in front of the printing device, the printing device automatically takes a picture of the user and compares the picture with a database to identify the user; if there is print data addressed for the user, the user is notified of a message including the distinguishing information about the user and the user can output the print data on the spot. The user does not need to voluntarily go to the printing device and operate it to check for the presence or absence of print data addressed for the user.

Specifically, distinguishing information about users who use the printing device, such as users' IDs and users' names, is recorded in a recording section or the like in the server or the printing device in connection with image information such as face images and the amount of physical characteristics. A photographing camera or the like for taking pictures of persons who pass near the printing device is mounted in or connected to the printing device. The photographing camera randomly takes pictures of persons who pass in front of the printing device. Image information about a user photographed is compared with the image information registered in advance to identify the user who passed in front of the printing device. If there is print data addressed for the identified user, such as a confidential print or confidential facsimile, a message including the distinguishing information about the user is output from a speaker to call the user's attention so that the user outputs print data on the spot.

Accordingly, the user can know the presence or absence of print data addressed for the user without awareness, that is, independently of the user's intention, so the user does not need to take the trouble to go to the printing device many times so as to check for the presence or absence of print data or to go to the printing device to output the print data after being notified that there is print data. This can greatly enhance convenience for users.

### EXAMPLE

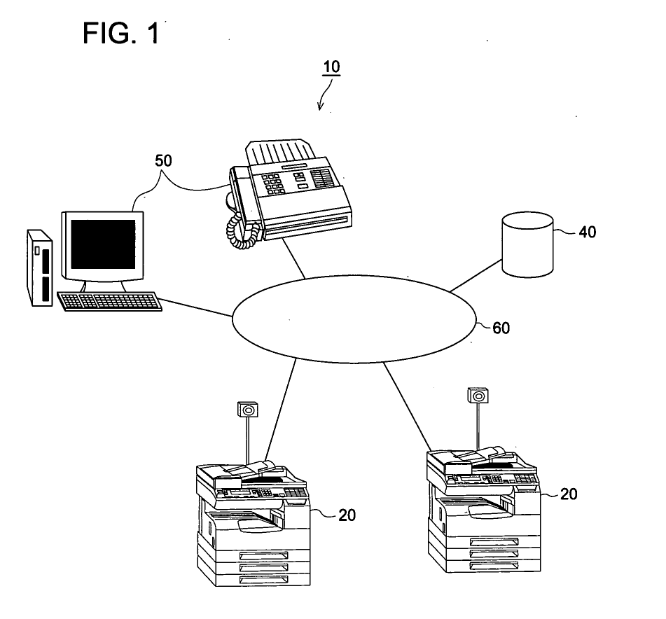

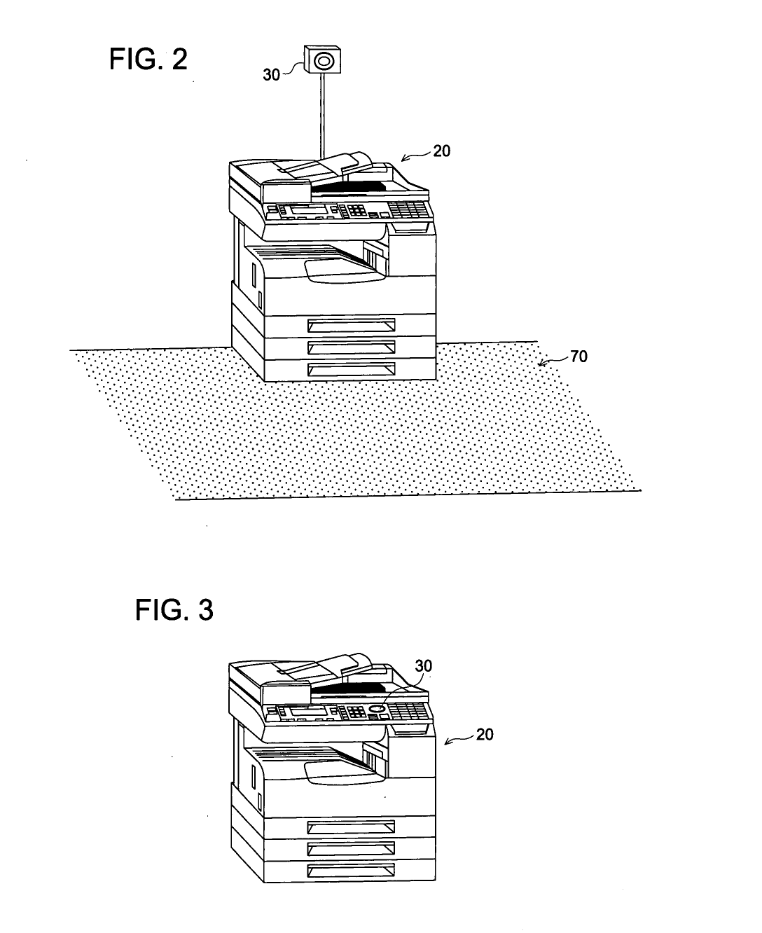

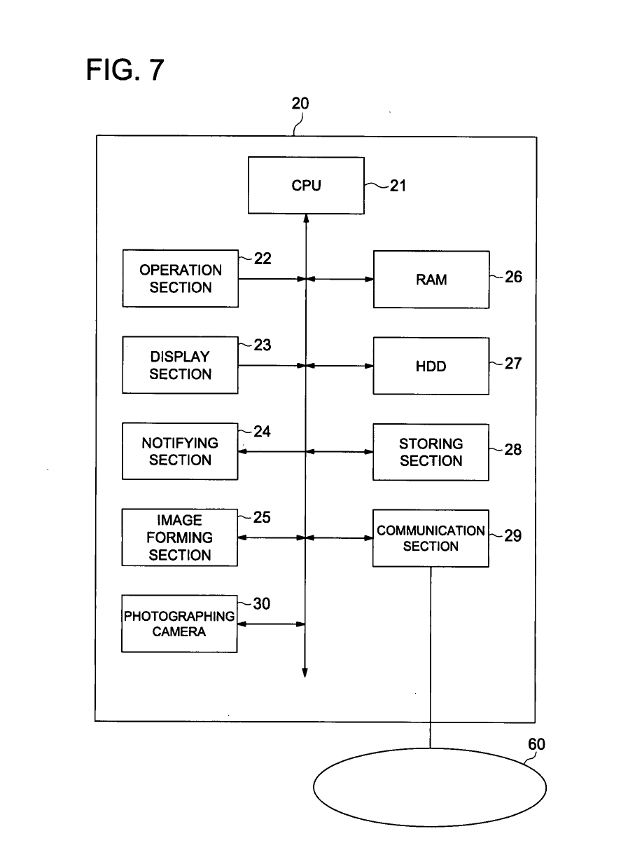

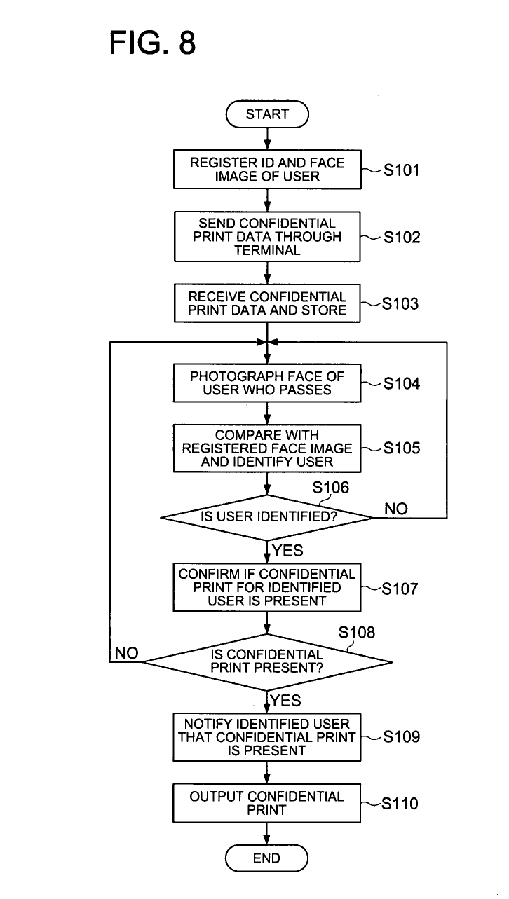

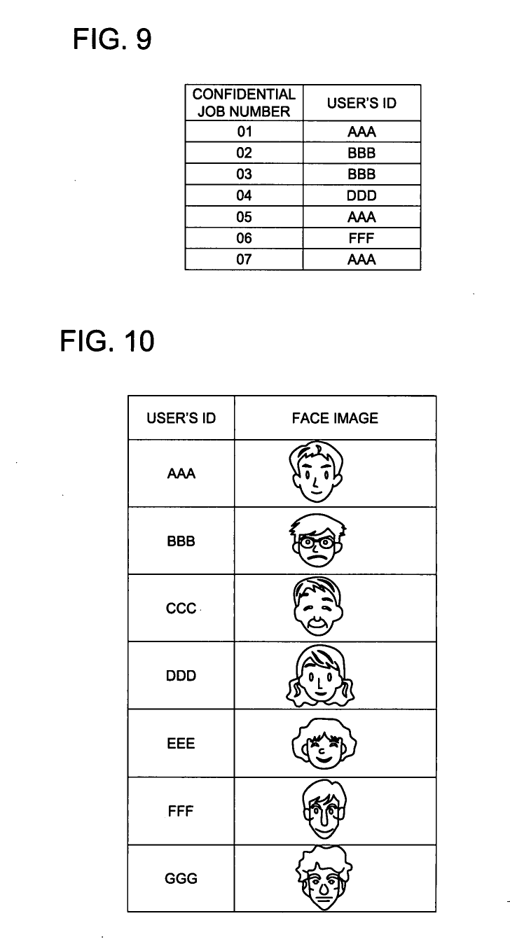

To describe the above embodiment of the present invention in more detail, a printing device, printing system, print control method, and print control program according to an embodiment of the present invention will be described with reference to FIGS. 1 to 10. FIG. 1 schematically shows the structure of a printing system in this embodiment of the present invention. FIGS. 2 to 6 show exemplary structures of the printing device. FIG. 7 is a block diagram showing the structure of the printing device in this embodiment. FIG. 8 is a flowchart indicating a procedure for outputting a confidential print. FIG. 9 indicates an exemplary job yet to be output. FIG. 10 shows the relation between users' IDs and face images.

As shown in FIG. 1, in the printing system 10 in this embodiment, interconnected over a communication network 60 such as a local area network (LAN) or telephone line are one or a plurality of terminals 50 such as a computer for forming and sending print data and a facsimile machine, one or a plurality of printing devices 20 for receiving the print data and outputting it to a paper medium or the like, and a server 40 for recording information about users who use the printing devices 20 and other information.

The printing device 20 in this embodiment is installed on a passageway 70 or in another place in an office through which a plurality of users pass, as shown in FIG. 2. A photographing camera 30 for taking images of users who pass through the passageway 70 is mounted at a prescribed position on the printing device 20 (the images may be visible images or images at wavebands other than the visible wavebands, such as infrared images).

There are no restrictions on the type, size, and shape of the photographing camera 30, but the photographing camera 30 is preferably mounted in a place where a face can be photographed easily to overlook the circumference of the printing device 20 and to take a face image suitable for authentication. For example, it is preferable to attach a supporting rod to the printing device 20, mount the photographing camera 30 on the supporting rod, and perform photography at a position equal to or slightly higher than the height of the face to eliminate effects by illumination and other factors. When a user passing near the printing device 20 is photographed, if another user is also photographed on the background, user authentication will become difficult. Therefore, the background is preferably made approximately uniform by installing a partition or the like on the side opposite to the printing device 20 with respect to the passageway 70.

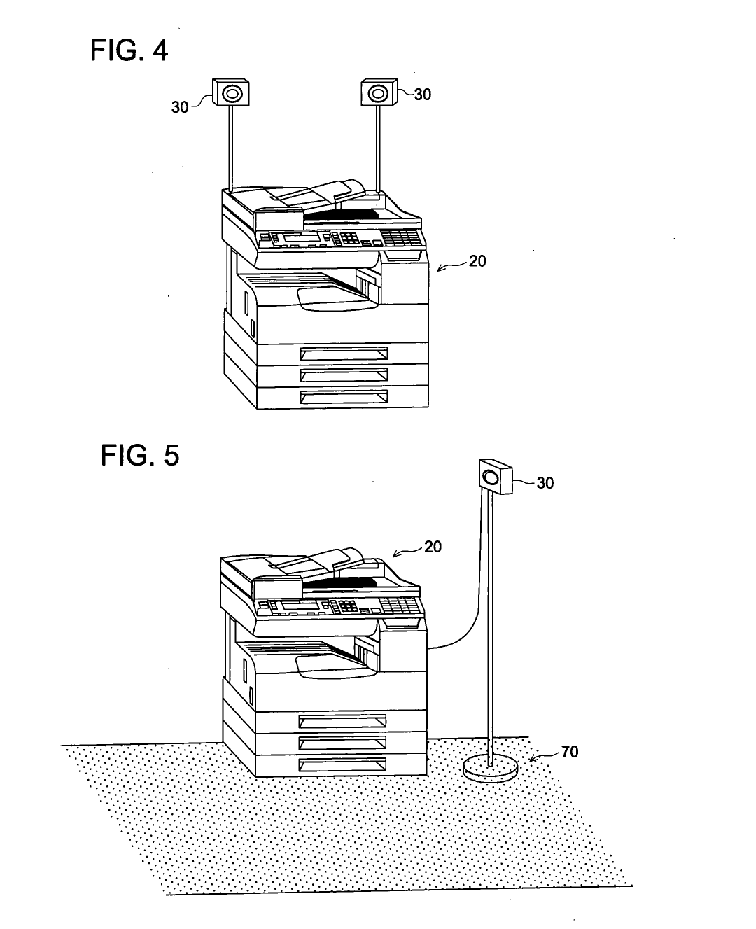

The photographing camera 30 can be mounted in an arbitrary place. As shown in FIG. 3, for example, the photographing camera 30 may be mounted at a prescribed position on the panel of the printing device 20. A printed matter of a face image may be placed in front of the photographing camera 30, in which case if only one photographing camera 30 is used, the user may be authenticated incorrectly. To eliminate this problem, as shown in FIG. 4, for example, a plurality of photographing cameras 30 may be mounted and images taken by the plurality of photographing cameras 30 may be compared.

In the arrangement shown in FIG. 2, a side face of the user passing the printing device 20 is photographed, probably making user authentication difficult. Accordingly, as shown in FIG. 5, for example, the photographing camera 30 may be separated from the printing device 20 and mounted on the passageway 70 so as to take a picture near the front face of the user. Alternatively, the photographing camera 30 may be mounted on a gate provided on the passageway 70.

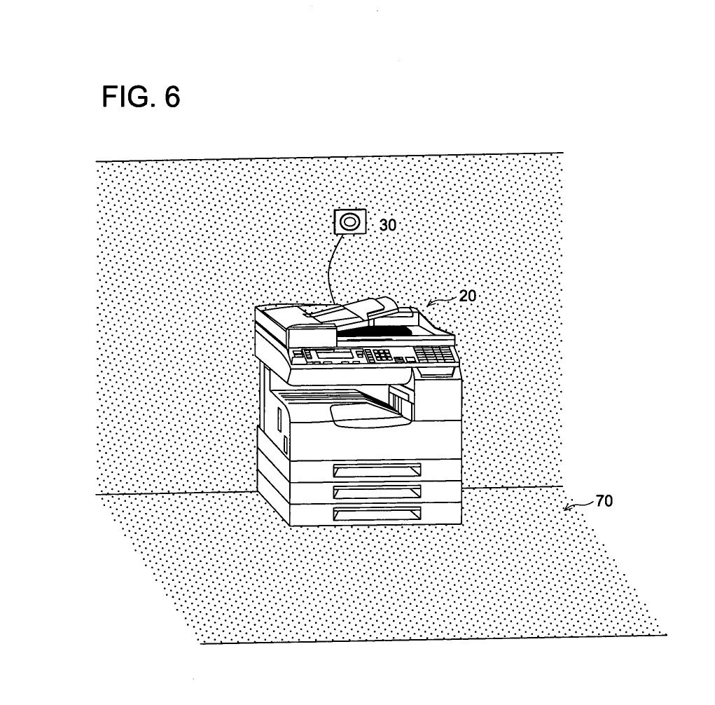

Some users may be reluctant to be photographed when the presence of the photographing camera 30 is conspicuous. Accordingly, as shown in FIG. 6, for example, the photographing camera 30 may be embedded in the wall behind the printing device 20, and a half mirror or the like may be further provided in front of the photographing camera 30 to make the presence of the photographing camera 30 difficult to recognize.

Next, the structure of the printing device 20 described above will be specifically described with reference to FIG. 7. The printing device 20 according to this embodiment is provided with an operation section 22, which includes buttons used to set values for the printing device 20 and enter users' IDs and passwords; a display section 23, such as a liquid crystal panel, for displaying various states of the printing device 20 (alternatively, a touch panel having both the operation section 22 and the display section 23 may be used); a notifying section 24, such as a speaker, for indicating the various states of the printing device 20 by means of sounds and for outputting a message including distinguishing information about a user identified by a method described below so as to notify the user that there is print data addressed for the user; an image forming section 25 for printing print data, which is received by use of a printer function or facsimile function or read by use of a scanner function, on a paper medium or the like and then fixing the print data; a photographing camera 30 for taking a picture of a user who passes near the printing device 20 (the photographing camera 30 may be separated from the printing device 20); a memory section, which includes a random access memory (RAM) 26 and hard disk drive (HDD) 27, for recording print data and also recording distinguishing information (users' IDs, user's names, etc.) about users who use the printing device 20, in connection with users' image information (including face images and the amount of physical characteristics extracted from the face image); a storing section 28 for storing printed paper media and the like in user-specific trays or similar containers; a communication section 29 for transmitting and receiving print data, distinguishing information, image information, etc. over a communication network 60; and a central processing unit (CPU) 21 for controlling these sections.

The CPU 21 functions as an authentication section for identifying a user by comparing the user's image information captured by the photographing camera 30 with the image information recorded on the HDD 27, and also function as a notification controller for causing the notifying section 24 to output a message including the user's information (such as the user's ID and user's name) if there is print data addressed for the identified user. The authentication section and notifying section may be included in the printing device 20 as hardware components. Alternatively, these sections may be configured as a print control program that causes the computer to function as the authentication section and notifying section and operates on the printing device 20.

The structure shown in FIG. 7 is just an example; when distinguishing information about a user is recorded in the server 40 in connection with image information of the user, for example, the HDD 27 may be omitted; when there is no need to record printed matters that have been already output, the storing section 28 may be omitted. Conversely, sections not shown in FIG. 7 may be added.

Next, a procedure for outputting print data addressed for the identified user will be described with reference to the flowchart shown in FIG. 8. In the description that follows, a case in which a confidential print is output will be described, but the flowchart can also be applied to arbitrary printing for which a user who receive a printed matter is specified, such as for confidential facsimile and data output by the user from the terminal 50, in the same way.

First, in step S101, distinguishing information (users'ID and users' name) about users is registered in connection with image information about the users (including face images and the amount of physical characteristics), as a database as shown in FIG. 10. There are no restrictions on the method for registration in the database; for example, each user may operate the operation section 22 on the printing device 20, enter the user's own ID and name, and then take a face image of the user by using the photographing camera 30. Another way for registration in the database is to operate the operation section of the terminal 50 of each user, enter the user's own ID and name, connect a digital camera to the terminal 50 to take a face image of the user, and send the user's ID and user's name to the printing device 20 or server 40 in connection with the face image taken.

A face image to be registered may be a front face image, as shown in FIG. 10, which is obtained when the user is photographed from the front, or a side face image, which is obtained when the user is photographed from a side to match a situation in which the user is photographed with the photographing camera 30 when the user passes near the printing device 20. To increase the precision of authentication, a right side image and a left side images may be combined, or a side face image and a front face image may be combined. A photographed image may be registered without alteration, or may be processed by, for example, extracting contours before the image is registered. The face image may be a colored image including lightness and saturation or a monochrome image including only lightness. Face images are used here as image information about users, but, for example, upper-body images or whole-body images may be used. The amounts of physical characteristics extracted from photographed images may be registered, as described below.

When, in step S102, confidential print data is sent from the terminal 50 with a user's ID, user's name, and password specified, the communication section 29 in the printing device 20 receives print data addressed for an identified user over the communication network 60 and records the print data in the RAM 26 or on the HDD 27 in connection with the user's ID, user's name, and password, in step S103. The above print data is defined as a job that comprises image data as well as an encrypted user's ID, user's name, and password; the image data is sent to the printing device 20 together with the user's ID, user's name, and password entered by use of a printer driver in the terminal 50, as the print data.

When a user on the passageway 70 passes near the printing device 20, the photographing camera 30 takes a picture of the face of the user at random in step S104. The authentication section of the printing device 20 compares the photographed face image with the face images registered in the database in advance to identify the user in step S105. Although a specific method for identifying a user will be described below, known image processing technology can also be used for user identification and the present invention is not limited to the method below.

Specifically, a face area in the photographed image is first detected. Then, the face image is cut out and normalization is performed. For example, a photographed image not including the user and a photographed image including the user are compared to remove the background. The face is identified from contours, hues (flesh colors portion), and the like of the image resulting from removing the background, and the face image is cut out. In general, the face areas in face images that have been cut out in this way include variations in size, inclination, and lightness, so normalization is performed to compensate for these variations.

Next, information that represents characteristics of the face by use of digits or equations is extracted as the amount of face characteristics (the amount of physical characteristics). The amount of physical characteristics is geometric characteristics including the shapes of parts on the face and relations between relative positions, or pattern distribution characteristics including colors on the face surface and a color intensity distribution. For the geometric characteristics, for example, the eyes, nose, mouth, ears, eyebrows, etc. are identified from positional relations on the face image and then contour lines and characteristic points (positions of the eye tails, both points of the mouth, the top of the jaw, etc.) representing the structure and shape of the face are extracted so as to obtain distances and angles among characteristic points as well as curvatures of the contour lines.

User comparison processing is then performed. A face image having the characteristic amount most analogous to the characteristic amount of the extracted face is found from the database registered in step S101 according to a face comparison algorithm such as the eigenface method, constrained mutual subspace method, local feature analysis (LFA) method, projection elastic graph matching method, or neutral network method. The user is then identified according to the distinguishing information registered in connection with the selected face image. The face characteristic amount may be extracted by the procedure described above and registered in the database, instead of registering the face image. In this case, it suffices to compare the characteristic amount extracted from the photographed face image with the characteristic amount registered in the database and identify the user according to the distinguishing information registered in connection with the selected characteristic amount.

If the user cannot be identified in step S106, that is, a face image having a characteristic amount analogous to the extracted face characteristic amount is not registered (producing a “No” result), the processing returns to step S104 and a next user is photographed. If the user can be identified in step S106, that is, a face image having a characteristic amount analogous to the extracted face characteristic amount is registered (producing a “Yes” result), the processing proceeds to step S107 and checks whether there is a confidential print addressed for the user. Since jobs (image data) in the printing device 20 are stored in connection with users' IDs as shown in FIG. 9, whether a confidential print has arrived can be checked with ease.

If no confidential print has arrived in step S108 (producing a “No” result), the processing returns to step S104 and a next user is photographed. If it is confirmed that a confidential print has arrived in step S108 (producing a “Yes” result), the processing proceeds to step S109, in which the notification controller in the printing device 20 uses the notifying section 24, such as a speaker, to output a message, including the user's ID and user's name, that says, for example, “there is a confidential print addressed for AAA” when there is a confidential print addressed for a user having a user's ID AAA.

As another notifying method, a user's ID or user's name may be output. When, however, only a few users pass near the printing device 20, it is sufficient to give a prescribed alarm or chime to notify the relevant user that there is a confidential print addressed for the user. When a sound is made toward the user for notification by using a directional speaker, the user can be reliably notified that there is a confidential print. Other possible notifying methods include blowing air to the user, turning on and off a light emitting means such as an LED or lamp, and giving a display or vibration by using a function of the user's card, mobile telephone, or another possession.

The user then enters the user's ID and password by operating the operation section 22 on the printing device 20 in order to output the confidential print addressed for the user in step S110. When the confidential print is output, the photographing camera 30 photographs the user near the printing device 20, so the authentication section can determine whether the user matches the user for which the confidential print is addressed. Accordingly, it is also possible for the user to output the confidential print without having to enter the user's ID and password. Operation by the user can be simplified and thereby convenience is further improved.

In step S103, the print data has been recorded in the RAM 26 or on the HDD 27 in connection with the user's ID, user's name, and password. Instead, the print data may be output and the resulting printed matter may be stored in advance in the storing section 28, such as a user-specific tray, provided in the printing device 20. In step S110, the confidential print stored in the tray of the user may be ejected when the user enters the user's ID and password by operating the operation section 22 on the printing device 20.

Thus, when the photographing camera 30 is integrated into or provided separately and connected to the printing device 20 mounted on the passageway 70 through which users frequently pass and distinguishing information for each user using the printing device 20 is registered in connection with image information, a user passing near the printing device 20 is identified by photographing the user with the photographing camera 30 and comparing captured image information with the image information recorded in advance. If there is a confidential print addressed for the identified user, the user is notified of a message including the distinguishing information about the user. Accordingly, the user does not need to go to the printing device 20 and enter the user's ID and password to check whether there is a confidential print or to take trouble to go to the printing device 20 to print the confidential print. The user can simply know that there is print data addressed for the user, and can output the print data on the spot.

Although, in the above embodiment, a case in which the photographing camera 30 is used has been described, the present invention is not limited to the embodiment. If information necessary for user authentication is obtained, any device other than a camera may be used.

If, for example, the user always carries an employee IC card in which a radio frequency identification (RFID) tag (preferably, a microwave RFID tag with which communication is possible at a distance several meters apart) or another authentication medium is included, a reading section, such as an RFID reader or RFID reader and writer, may be provided instead of the photographing camera and users may be authenticated according to authentication information recorded in the IC chip of the RFID tag. In this case, distinguishing information and authentication information are registered on a one-to-one basis for each user who uses the printing device 20, and the antenna of the RFID reader or RFID reader/writer is mounted on the passageway 70 or a wall or a gate antenna is mounted on the passageway 70. When resonance is caused between this antenna and the antenna disposed on the RFID tag, the authentication information recorded in the IC chip of the RFID tag is read by means of electromagnetic induction or electromagnetic coupling, enabling the user to be identified.

The present invention is applicable to an arbitrary printing device, a system including the printing device, a print control method used by the printing device or the system, and a print control program operating in the printing device or the system.

According to the printing device, printing system, print control method, and print control program in this aspect, effects described below are provided.

A first effect is to reliably notify a particular user of print data such as a confidential print or confidential facsimile addressed for the particular user, if any, without a special operation having to be done.

This is because distinguishing information is registered in advance in connection with image information or authentication information for each user who uses the printing device, a photographing section for photographing a user near the printing device or a reading section for reading authentication information from an authentication medium possessed by the user near the printing device is integrated into or provided separately and connected to the printing device, and the printing device includes, as hardware or software components, an authentication section for identifying the user by comparing image information obtained through photographing or the read authentication information with the image information or authentication information registered in advance as well as a notification controller for causing a notifying section to make a notification of a message including the distinguishing information about the user when there is a job yet to be output for the identified user; thereby the user can know that there is print data destined for the user just by passing in front of the printing device.

A second effect is to enable a user to output print data, such as a confidential print or confidential facsimile, addressed for the user immediately.

This is because, in the structure described above, the user is notified that there is print data addressed for the user when the user passes in front of the printing device and thus the user can output the print data on the spot. Another reason is that a user authenticated by the authentication section is permitted to output the print data without entering the user's ID and password.

What is claimed is:

1. A printing device capable of performing printing for which a user who receives a printed matter is specified, the printing device comprising:
(a) an authentication section which identifies a user who approaches the printing device; and
(b) a notification controller which causes a notifying section to make a notification of prescribed information when a job to be outputted for the identified user is registered.

2. The printing device of claim 1, further comprising a photographing section which photographs a user in the vicinity of the printing device,
wherein the authentication section identifies the photographed user by comparing photographed image information of the user with image information registered in advance in connection with distinguishing information about the user who uses the printing device.

3. The printing device of claim 2, wherein the image information registered in advance is a face image or an amount of physical characteristics extracted from the face image.

4. The printing device of claim 1, further comprising a reading section which reads authentication information from an authentication medium possessed by a user in the vicinity of the printing device without contacting the medium,
wherein the authentication section identifies the user by comparing the read authentication information of the user with authentication information registered in advance in connection with distinguishing information about the user who uses the printing device.

5. The printing device of claim 1, wherein the notification controller causes the notifying section to make a notification of a message including the distinguishing information about the user.

6. The printing device of claim 5, wherein the distinguishing information of the user is user's identification or user's name given to the user, and the message is a message notifying that a job addressed for the user to be outputted is present.

7. The printing device of claim 1, wherein the job to be outputted includes at least one of a confidential print and a confidential facsimile.

8. A printing system comprising:
(a) one printing device or a plurality of printing devices capable of performing printing for which a user who receives a printed matter is specified; and
(b) a sever connected with the one printing device or the plurality of printing devices through a communication network, in which distinguishing information about a user who uses the printing device is registered in connection with image information of the user,
wherein at least one of the plurality of printing devices comprises an authentication section that identifies a user who approaches the printing device and a notification controller that causes a notifying section to make a notification of prescribed information when a job to be outputted for the identified user is registered.

9. The printing system of claim 8, further comprising a photographing section which photographs a user in the vicinity of the printing device,
wherein the authentication section identifies the photographed user by comparing photographed image information of the user with image information registered in advance in connection with distinguishing information about the user who uses the printing device.

10. The printing system of claim 9, wherein the image information registered in advance is a face image or an amount of physical characteristics extracted from the face image.

11. The printing system of claim 8, further comprising a reading section which reads authentication information from an authentication medium possessed by a user in the vicinity of the printing device without contacting the medium,
wherein the authentication section identifies the user by comparing the read authentication information of the user with authentication information registered in advance in connection with distinguishing information about the user who uses the printing device.

12. The printing system of claim 8, wherein the notification controller causes the notifying section to make a notification of a message including the distinguishing information about the user.

13. The printing system of claim 12, wherein the distinguishing information of the user is user's identification or user's name given to the user, and the message is a message notifying that a job addressed for the user to be outputted is present.

14. The printing system of claim 8, wherein the job to be outputted includes at least one of a confidential print and a confidential facsimile.

15. A print control method in which a printing device capable of performing printing for which a user who receives a printed matter is specified, the print control method comprising the steps of:
(a) authenticating to identify a user who approaches the printing device; and
(b) notifying to make a notification of prescribed information when a job to be outputted for the identified user is registered.

16. The print control method of claim 15, further comprising:
registering distinguishing information in connection with image information of the user, for each user using the printing device; and
photographing a user in the vicinity of the printing device,
wherein the authenticating step identifies the photographed user by comparing photographed image information of the user with image information registered in advance.

17. The print control method of claim 16, wherein the image information registered in advance is a face image or an amount of physical characteristics extracted from the face image.

18. The print control method of claim 15, further comprising:
registering distinguishing information in connection with authentication information of the user for each user using the printing device; and
reading authentication information from an authentication medium possessed by a user in the vicinity of the printing device without contacting the medium,
wherein the authenticating step identifies the user by comparing the read authentication information of the user with authentication information registered in advance in connection with distinguishing information about the user who uses the printing device.

19. The print control method of claim 15, wherein the notifying makes a notification of a message including the distinguishing information about the user.

20. The print control method of claim 19, wherein the distinguishing information of the user is user's identification or user's name given to the user, and the message is a message notifying that a job addressed for the user to be outputted is present.

21. The print control method of claim 15, wherein the job to be outputted includes at least one of a confidential print and a confidential facsimile.

22. A computer-readable storage medium having a program stored thereon that operates in a printing device capable of performing printing for which a user who receives a printed matter is specified, for causing a computer to perform a print control method comprising the steps of:
identifying a user in the vicinity of the printing device, who is photographed by a photographing section mounted in or connected to the printing device, by comparing image information about the user with image information registered in advance in connection with distinguishing information about the user who uses the printing device; and
causing a notifying section to make a notification of a message including the distinguishing information about the user when a job to be output for the identified user is registered.

23. The computer-readable storage medium of claim 22, wherein the image information registered in advance is a face image or an amount of physical characteristics extracted from the face image.

24. A computer-readable storage medium having a program stored thereon that operates in a printing device capable of performing printing for which a user who receives a printed matter is specified, for causing a computer to perform a print control method comprising the steps of:
identifying a user in the vicinity of the printing device, by comparing authentication information about the user with image information registered in advance in connection with distinguishing information about the user who uses the printing device, the authentication information being recorded in an authentication medium possessed by the user and read by a reading section mounted in or connected to the printing device; and
causing a notifying section to make a notification of a message including the distinguishing information about the user when a job to be output for the identified user is registered.

25. The computer-readable storage medium of claim 22, wherein the distinguishing information of the user is user's identification or user's name given to the user, and the message is a message notifying that a job addressed for the user to be outputted is present.

26. The computer-readable storage medium of claim 22, wherein the job to be outputted includes at least one of a confidential print and a confidential facsimile.
